(19) United States
(12) Patent Application Publication
(10) Pub. No.: US 2008/0094608 A1
(43) Pub. Date: Apr. 24, 2008

(54) Laser velocimetry system

(75) Inventors: David B. Holtkamp, Los Alamos, NM (US); Leonard J. Tabaka, Rio Rancho, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: The Regents of the University of California

(21) Appl. No.: 11/584,953

(22) Filed: Oct. 23, 2006

(51) Int. Cl. G01P 3/36

(52) U.S. Cl. 356/28.5; 356/28

(57) ABSTRACT

A laser velocimetry system that employs a low power laser. The laser has a power of up to about 100 mW. Light from the laser, in one embodiment, is directed through a multimode optical fiber and an optical probe to a surface of a moving sample. Doppler-shifted light from the surface is reflected back through the optical probe and multimode optical fiber to a circulator, which directs the light reflected from the surface to a second multimode optical fiber. Unshifted (i.e., non-Doppler shifted) light is also introduced into the optical signal path. The Doppler shifted reflected light and the unshifted light are then transmitted through the second multimode optical fiber to a detector, which converts the reflected light into an electronic signal. The electronic signal of the “beat” between the Doppler shifted light and unshifted light may then be digitized by an analyzer and used to determine the velocity of the moving surface. A method of determining the velocity of a moving object is also described.

### STATEMENT REGARDING FEDERAL RIGHTS

This invention was made with government support under Contract No. DE-AC 52-06 NA 25396, awarded by the U.S. Department of Energy. The government has certain rights in the invention.

### BACKGROUND OF INVENTION

The invention relates to the determination of the velocity of a moving sample. More particularly, the invention relates to an apparatus for determining such velocities. Even more particularly, the invention relates to an apparatus and method for determining such velocities using laser Doppler velocimetry.

The measurement of the velocity of a moving surface is of interest in the field of hydrodynamics and studies of shock-related phenomena, such as shock-induced melting. Velocimetry techniques, such as Photon Doppler Velocimetry (also referred to herein as “PDV”), Fabry-Perot interferometry, and Velocity Interferometry System for Any Reflector (also referred to herein as “VISAR”) typically rely on interferometry on Doppler shifted light. PDV in particular relies on the principle that, by interfering unshifted light with Doppler shifted light, a signal having a frequency that is directly proportional to the velocity of the moving surface may be obtained. Such techniques typically require instrumentation that is large in size, costly, and complicated to field. In particular, lasers used in such techniques often must operate at high power.

Because of their large size and complexity, current velocimetry techniques cannot be easily adapted for applications where considerations such as weight, power, and size are critical. Therefore, what is needed is a velocimeter that is compact. What is also needed is a velocimeter using a laser that operates at low power.

### SUMMARY OF INVENTION

The present invention meets these and other needs by providing a laser velocimetry system that employs a low power laser. In one embodiment, the laser has a power of up to about 100 mW. Light from the laser, in one embodiment, is directed through a multimode optical fiber and an optical probe to a surface of a moving sample. Doppler shifted light from the surface is reflected back through the optical probe and multimode optical fiber to a circulator, which directs the light reflected from the surface to a second multimode optical fiber. Unshifted (i.e., non-Doppler shifted) light is also introduced into the optical signal path. The Doppler shifted reflected light and the unshifted light are then transmitted through the second multimode optical fiber to a detector, which converts the reflected light into an electronic signal. The electronic signal of the “beat”—i.e., the difference in frequency between the Doppler shifted light and unshifted light—may then be digitized by an analyzer and used to determine the velocity of the moving surface. A method of determining the velocity of a moving object is also described.

Accordingly, one aspect of the invention is to provide a laser velocimetry system. The laser velocimetry system comprises a laser velocimeter. The laser velocimeter comprises: a laser, wherein the laser provides a laser beam; an optical probe optically coupled to the laser, wherein the optical probe directs the laser beam to a surface of a sample and receives Doppler shifted light reflected from the surface of the sample; a first multimode optical fiber having a first end optically coupled to the optical probe, wherein the first multimode optical fiber receives the Doppler shifted light reflected from the sample from the optical probe; and a circulator optically coupled to a second end of the first multimode optical fiber, wherein the circulator receives the Doppler shifted light reflected from the sample and directs the Doppler shifted light to a detector that is optically coupled to the circulator by a second multimode optical fiber, wherein the detector receives unshifted light from the laser and the Doppler shifted light, and wherein the detector generates a signal from the unshifted light and the Doppler shifted light reflected from the surface of the sample. The laser velocimetry system also includes an analyzer, wherein the analyzer receives the signal from the detector and produces a digitized signal therefrom, and wherein the digitized signal is used to calculate at least one velocity of the surface of the sample.

A second aspect of the invention is to provide a laser velocimeter. The laser velocimeter comprises: a laser, wherein the laser provides a laser beam; and a first multimode optical fiber optically coupled to the laser. The first multimode optical fiber passes through a circulator that directs the laser beam through the first multimode optical fiber to an optical probe that is optically coupled to the first multimode optical fiber. The optical probe directs the laser beam to a surface of a sample and receives Doppler shifted light reflected from the surface of the sample and transmits the Doppler shifted light reflected from the surface of the sample back through the first multimode optical fiber to the circulator. The circulator directs the Doppler shifted light reflected from the surface of the sample into a second multimode optical fiber optically coupled to the circulator. The laser velocimeter also comprises a detector optically coupled to the circulator by the second multimode optical fiber, wherein the detector receives unshifted light from the laser and the Doppler shifted light, and wherein the detector generates a signal from the unshifted light and the Doppler shifted light reflected from the surface of the sample.

A third aspect of the invention is to provide a laser velocimeter system. The laser velocimeter system comprises a laser velocimeter. The laser velocimeter comprises: a laser, wherein the laser provides a laser beam having a power of up to 100 mW; and a first multimode optical fiber optically coupled to the laser. The first multimode optical fiber passes through a circulator that directs the laser beam through the first multimode optical fiber to an optical probe that is optically coupled to the first multimode optical fiber. The optical probe directs the laser beam to a surface of a sample and receives Doppler shifted light reflected from the surface of the sample, wherein the optical probe transmits the Doppler shifted light reflected from the surface of the sample back through the first multimode optical fiber to the circulator. The circulator directs the Doppler shifted light reflected from the surface of the sample into a second multimode optical fiber optically coupled to the circulator. The laser velocimeter also comprises a detector optically coupled to the circulator by the second multimode optical fiber, wherein the detector receives unshifted light from the laser and the Doppler shifted light reflected from the surface of the sample, and wherein the detector generates a signal from unshifted light and the Doppler shifted light reflected from the surface of the sample. The laser velocimeter system also comprises an analyzer, wherein the analyzer receives the signal from the detector and produces a digitized signal therefrom, and wherein the digitized signal is used to calculate at least one velocity of the surface of the sample.

A fourth aspect of the invention is to provide a method of determining the velocity of a moving object. The method comprises the steps of: directing a laser beam to a surface of the moving object; receiving Doppler shifted light reflected from the surface using an optical probe; transmitting the Doppler shifted light reflected from the surface from the optical probe through a first multimode optical fiber to a circulator; directing the Doppler shifted light reflected from the surface from the circulator to a second multimode optical fiber; transmitting unshifted light from the laser and the Doppler shifted light reflected from the surface through the second multimode fiber to a detector, wherein the detector generates a signal from the unshifted light and the Doppler shifted light reflected from the surface; and determining the velocity from the signal.

These and other aspects, advantages, and salient features of the present invention will become apparent from the following detailed description, the accompanying drawings, and the appended claims.

### BRIEF DESCRIPTION OF THE DRAWINGS

FIG. 1 is a schematic representation of a laser velocimeter of the present invention;

FIG. 2 is a schematic representation of a laser velocimeter having a beam splitter and a variable retroreflector located between the circulator and the optical probe;

FIG. 3 is a schematic representation of a laser velocimeter having a beam splitter and a variable retroreflector located between the laser and the circulator;

FIG. 4 is a schematic representation of a laser velocimeter having a fiber stretcher;

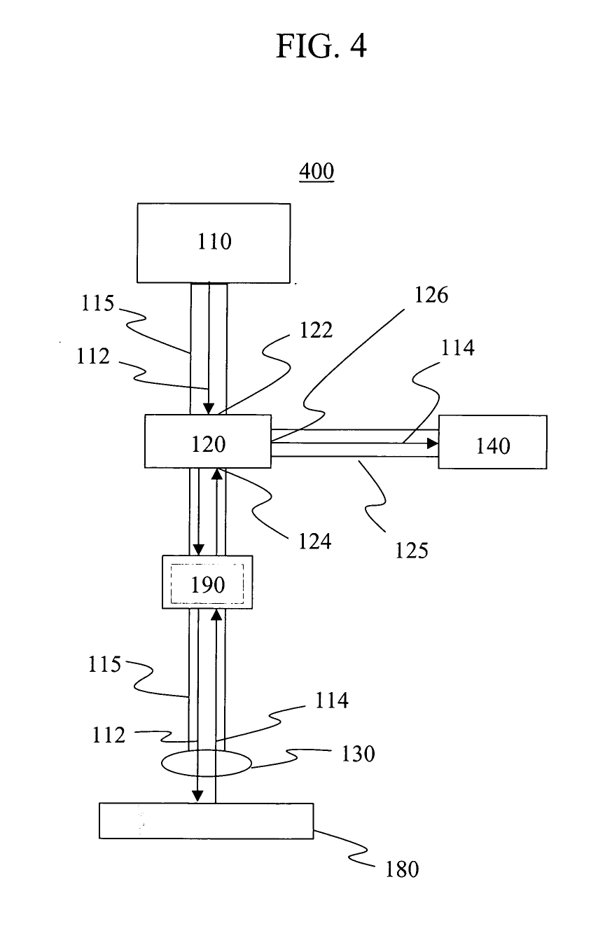

FIG. 5 is a flow chart for a method of measuring the velocity of a moving object;

FIG. 6 is a plot of raw data, obtained using the laser velocimetry system, for a moving metal foil;

FIG. 7 is a plot of an expanded portion of FIG. 6 near the time of first motion; and

FIG. 8 is a plot of velocities determined from the data shown in FIG. 6.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. In addition, whenever a group is described as either comprising or consisting of at least one of a group of elements and combinations thereof, it is understood that the group may comprise or consist of any number of those elements recited, either individually or in combination with each other.

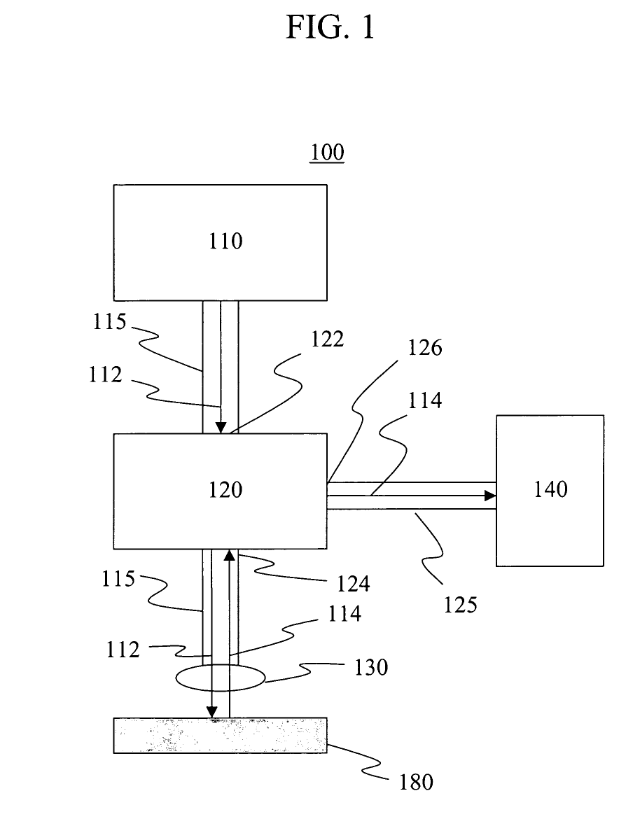

Referring to the drawings in general and to FIG. 1 in particular, it will be understood that the illustrations are for the purpose of describing a particular embodiment of the invention and are not intended to limit the invention thereto. Turning to FIG. 1, a laser velocimeter of the present invention is schematically shown. Laser velocimeter 100 includes a laser 110 that produces a laser beam 112 having a predetermined wavelength and line width. Laser 110 may be, for example, a diode laser, a fiber laser, or the like. In one embodiment, laser 110 is a photodiode laser having a wavelength of about 1550 nm and a line width of up to about 1 MHz.

Laser 110 is optically coupled to an optical probe 130 that directs the laser beam 112 onto a moving surface 180 of a sample such that moving surface 180 is illuminated by laser beam 112. Optical probe 130 comprises at least one of a lens or lenses, a tapered fiber, or a bare fiber probe. The combination of these various components that is actually used depends upon experimental conditions.

In one embodiment, laser 110 is coupled to optical probe 130 by a first multimode optical fiber 115, which passes through a circulator 120. First multimode optical fiber 115 enters circulator 120 through first fiber port 122 and exits circulator 120 through second fiber port 124. Circulator 120 uses optical components known in the art to function as a unidirectional device that directs an optical signal—such as laser beam 112—from first fiber port 122, for example, to second fiber port 124 with over 90% efficiency each way through it in its designed directions.

Rather than using first multimode optical fiber 115 and circulator 120 to couple laser 110 and optical probe 130, laser 110 may be optically coupled to optical probe 130 by illuminating optical probe 130 with laser beam 112 through a separate optical fiber, which may be either single mode or multimode. This may be accomplished using optics such as, but not limited to, mirrors, lenses, and the like that are well known in the art.

The light reflected by the moving surface 180 of a sample undergoes a Doppler shift. Laser Doppler velocimetry works on the principle that, by interfering unshifted laser light with Doppler shifted light reflected by moving surface 180, a signal—or beat frequency—a frequency that is directly proportional to the velocity of moving surface 180 can be obtained. The beat frequency F_{b} (also referred to as “beat”) may be approximated by the expression

F_{b}=F_{d}−F₀=2(V/c)F₀,

where F₀ is the original unshifted laser frequency, F_{d} is the Doppler shifted frequency, V is the velocity of the moving surface, and c is the speed of light. The expression can be rewritten in terms of V, F_{b}, and the unshifted laser wavelength λ:

V=λ/2·F_{b,} where λ=(c/F₀).

The Doppler shifted reflected light 114 from moving surface 180 reenters first multimode optical fiber 115 through optical probe 130 and travels back to circulator 120, entering circulator through second fiber port 124. The Doppler shifted reflected light 114 then exits circulator 120 through third fiber port 126 along a second multimode optical fiber 125, which is connected to a detector 140, where the optical signals (i.e., unshifted light from laser 110 and the Doppler shifted reflected light 114) are converted to an electrical or digital signal.

In one embodiment, unshifted light from laser 110 is back-reflected from optical probe 130. The back reflected unshifted light then follows the same path as the Doppler shifted reflected light, reentering first multimode optical fiber 115, entering circulator through second fiber port 124, exiting circulator 120 through third fiber port 126 along second multimode optical fiber 125, which is connected to detector 140.

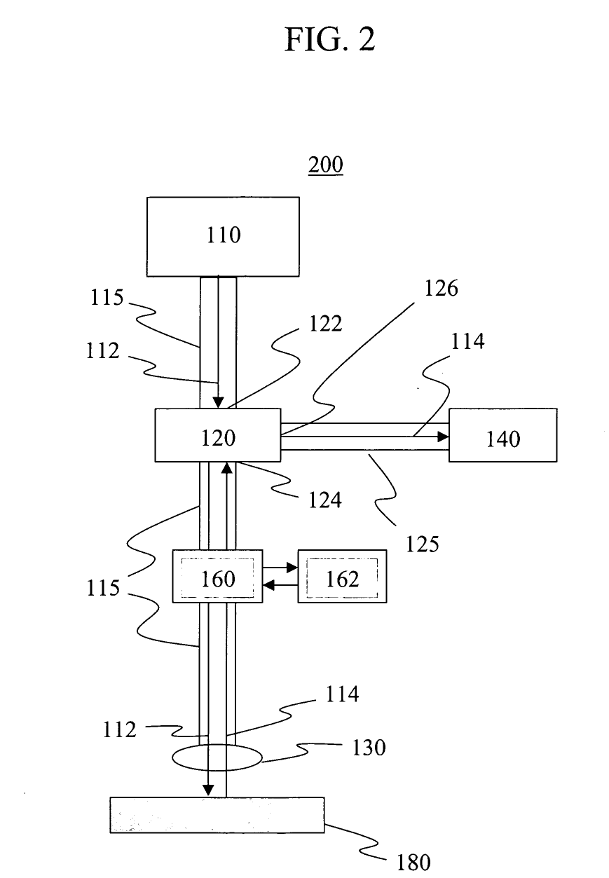

In another embodiment, shown in FIG. 2, a beam splitter 160 is optically coupled to first multimode optical fiber 115 between circulator 120 and optical probe 130. Beam splitter 160 splits off a portion of unshifted light in laser beam 112 before the beam enters optical probe 130. Beam splitter 160 directs the portion to a variable retroreflector 162. Beam splitter splits of about 10% of laser beam 112 to variable retroreflector 162. Variable retroreflector 162 reflects the unshifted light back into first multimode optical fiber 115, where it travels along with the Doppler shifted reflected light back toward circulator 120 through second fiber port 124. The unshifted light and the Doppler shifted reflected light then exit circulator 120 through third fiber port 126 along second multimode optical fiber 125, which is optically coupled to detector 140, as previously described. By allowing the amount of unshifted light be adjusted, varied, or both, the addition of beam splitter 160 and variable retroreflector 162 allows the signal generated by the laser velocimeter to be optimized.

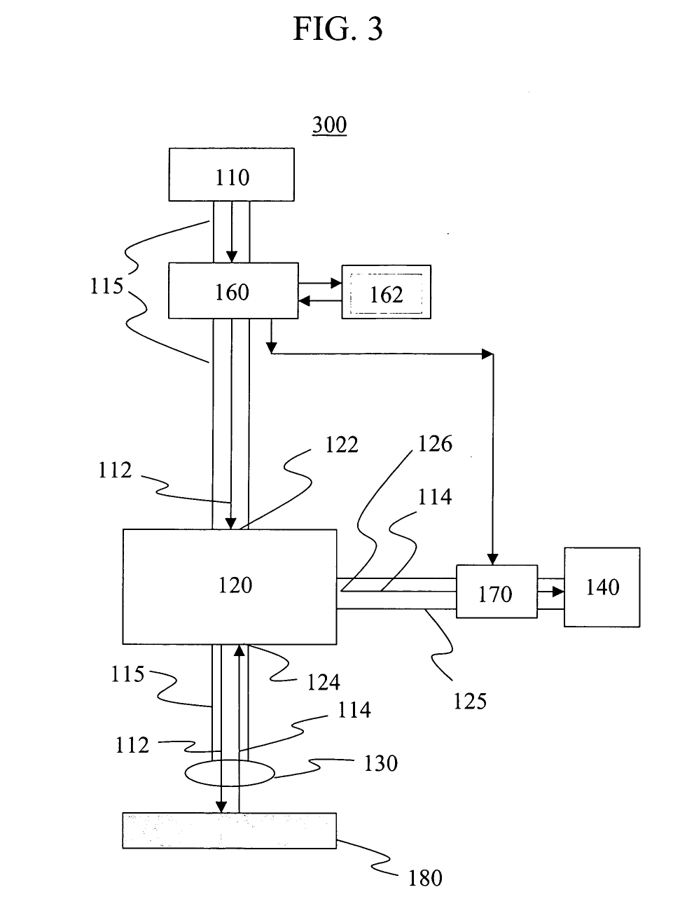

In another embodiment, shown in FIG. 3, beam splitter 160 is optically coupled to first multimode optical fiber 115 between laser 110 and circulator 120. As described above, a portion of unshifted light in laser beam 112 is split off by beam splitter 160 and directed to variable retroreflector 162. Rather than being reflected the back into first multimode optical fiber, however, the unshifted light is routed through a separate optical fiber to a combiner 170 that is optically coupled with second multimode optical fiber 125 and then on to detector 140 through second multimode optical fiber 125.

In order to facilitate set-up and optimize the signal generated by the laser velocimeter, Laser velocimeter 400 may also include a fiber stretcher 190 coupled to first multimode optical fiber 115 between circulator 120 and optical probe 130. Fiber stretcher 190 typically comprises a multimode optical fiber wrapped around a piezoelectric element. Fiber stretcher 190 introduces a synthetic signal that is similar to Doppler shifted light generated by moving surface 180. The synthetic signal generated by fiber stretcher 190 facilitates alignment and adjustment of the various components of laser velocimeter 400.

As previously described above, laser 110 may be optically coupled to optical probe 130 by illuminating optical probe 130 with laser beam 112 through a separate optical fiber; i.e., without being directed through first multimode optical fiber 115. In this instance, the Doppler shifted reflected light 114 from moving surface 180 enters first multimode optical fiber 115 through optical probe 130 and travels back to circulator 120, entering circulator through port 124.

In one embodiment, detector 140 comprises a photodiode that converts optical energy into an electrical signal. Detector 140 may further include an electrical amplifier, an optical amplifier that amplifies reflected light 114 before entering the detector, or both. The electrical signal generated by detector 140 is then transmitted to an analyzer (not shown) that produces a digitized signal of the electrical signal. The digitized signal may then be used to determine the velocity of moving sample 180. In instances where moving sample 180 comprises, for example, a number of members, each having a different velocity, the individual velocities—or the distribution of velocities—may be determined using analytical techniques such as Short Time Fourier Transforms (STFT), Hilbert transforms, and the like. The analyzer may be selected from those analyzers known in the art such as, for example, a transient digitizer, a digitizing oscilloscope, or the like.

Each of first multimode optical fiber 115 and second multimode optical fiber 125 may comprise either a graded index multimode optical fiber or step index multimode optical fiber, with graded index multimode fiber being preferred for transmitting higher fidelity signals over longer distances. Both first multimode optical fiber 115 and second multimode optical fiber 125 have a diameter in a range from about 9 microns to about 100 microns.

By using first multimode optical fiber 115 and second multimode optical fiber 125 rather than single mode optical fibers, the power requirements for laser 110 are reduced by a factor of 25 for even diffuse reflective surfaces. This allows a smaller laser such as, for example, a laser diode, to be substituted for much larger laser systems such as, for example, doubled YAG lasers that are typically used in VISAR and Fabry-Perot systems. In one embodiment, laser 110 has a power of up to about 100 mW. The lower power requirements for laser 110 also lead to a laser velocimeter 100 that is over 100 times smaller that comparable PDV, VISAR, and Fabry-Perot systems. Conversely, because first multimode optical fiber 115 and second multimode optical fiber 125 can accept about 25 times more laser power than single mode optical fiber velocimetry systems, much higher power lasers may be used in velocimeter 100. Higher power lasers, when combined with larger signal returns produced by detectors viewing the larger diameter multimode fibers, may enable use in applications—such as advanced multipoint velocimetry and hydrodynamics—that are inaccessible using current velocimetry methods.

The laser velocimeter 100 described herein may be used in those velocimetry applications that are currently served by PDV, VISAR, and Fabry-Perot velocimetry systems. Such applications include shock (both explosive and plate impact) experiments and non-shock accelerations, such as conventional, electromagnetic, high explosive-based accelerations, and the like. Because of its small size, laser velocimeter 100 may be used as a diagnostic tool in applications, such as in aircraft and spacecraft that are sensitive to weight, power, and size limitations.

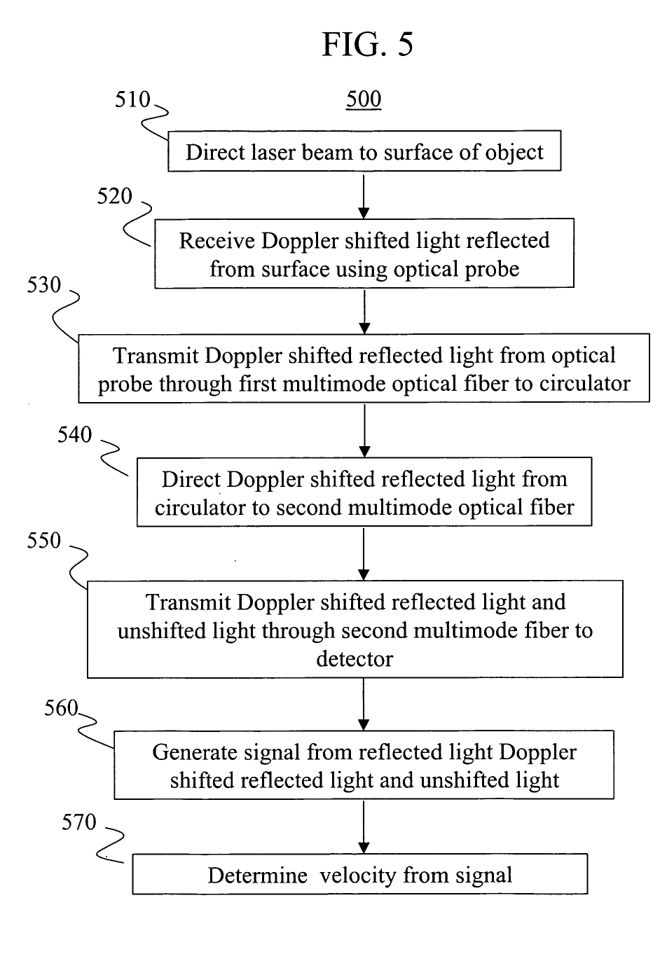

The invention also provides a method of measuring the velocity of a moving object. The method, which is outlined in the flow chart shown in FIG. 5, may be carried out using the velocimeter described hereinabove. In Step 510, a laser beam is directed to a surface of the moving object, providing unshifted light. In one embodiment, the laser beam is directed through a first multimode optical fiber and optical probe to the surface of the moving object. The first multimode optical fiber passes through a circulator. Alternatively, the laser illuminates the optical probe without being directed through the first multimode optical fiber. Doppler shifted light is reflected from the surface and received by the optical probe (Step 520). The Doppler shifted reflected light is transmitted from the optical probe through the first multimode optical fiber to the circulator (Step 530). In Step 540, the Doppler shifted light is directed from the circulator to a second multimode optical fiber. Unshifted light from the laser and the Doppler shifted reflected light are then transmitted through the second multimode optical fiber to a detector (Step 550) that then generates a signal from the unshifted light and the Doppler shifted reflected light (Step 560). The signal is then used to determine the velocity of the moving object (Step 570). The signal may then be transmitted to an analyzer, such as those previously described, where the signal is converted to a digitized signal. The digitized signal may then be analyzed using techniques that are well known in the art, such as Short Time Fourier Transforms (STFT), Hilbert transforms, and the like.

The velocities that can be measured by the velocimeter and velocimetry system described herein cover a range of about six orders of magnitude—from several mm/s to several km/s. In one embodiment, the velocimeter and velocimetry system are capable of measuring velocities in a range from about 1 mm/s to about 5 km/s. Lower and higher velocity ranges may be achieved, however, based upon parameters such as the types of detectors and amplifiers used and the length of the multimode optical fiber. Graded index multimode optical fibers may be used in lengths of up to hundreds of meters—i.e. to lengths less than about 1,000 meters. At this point, the highest observed frequencies begin to degrade in fringe contrast.

The following example illustrates various features and advantages of the invention, and is no way intended to limit the invention thereto.

### EXAMPLE 1

A laser velocimetry system such as that described hereinabove was constructed using the following components: a laser photodiode (JDS Uniphase Model CQF938/600) having a wavelength of 1550 nm; an optical circulator (Agiltron Part #OC-30511223) using a graded index multimode fiber; and a photodiode detector and amplifier (Miteq Model SCMR-50K6G-30-15-10-MM).

Using the above components, a moving metal foil was viewed with a bare fiber probe. The foil was viewed through the probe from a distance of several millimeters. Motion of the foil was induced by lightly tapping the foil. The data was obtained using the velocimetry system and the velocity of the foil was determined.

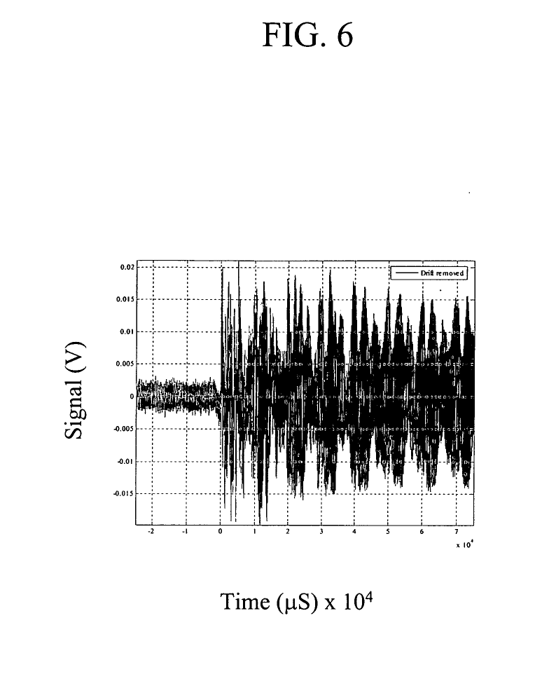

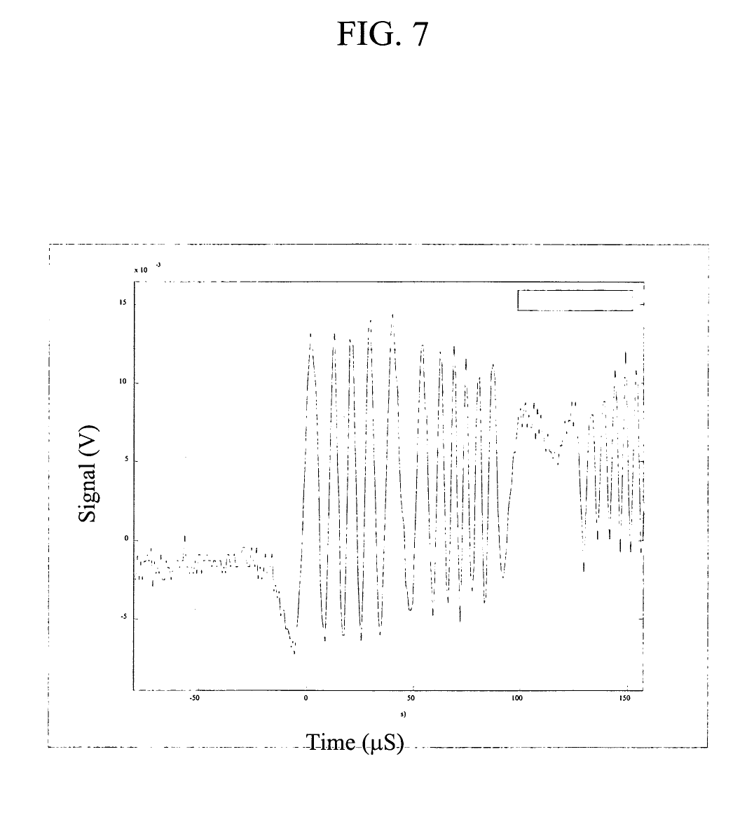

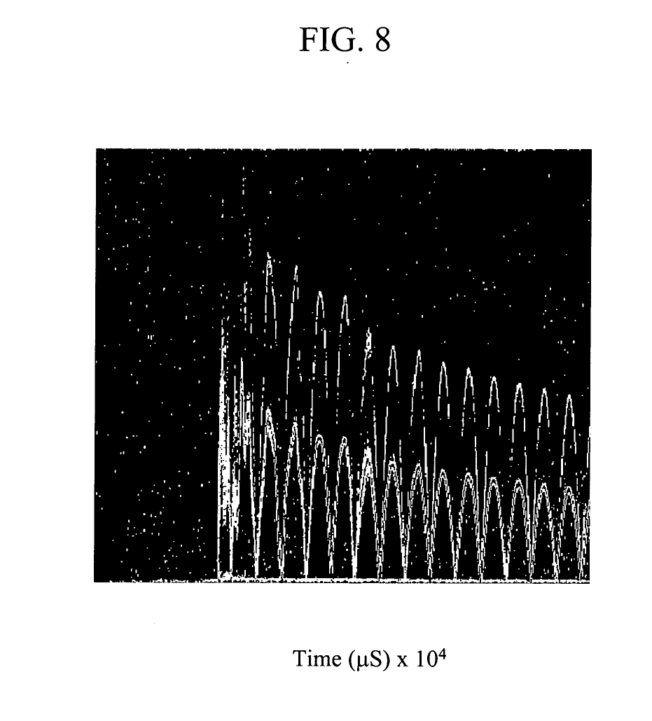

Samples of the data obtained from the experiment are shown in FIGS. 6, 7, and 8. The raw recorded data is shown in FIG. 6, and Figure FIG. 7 shows an expanded portion of FIG. 6 near the time of first motion. The velocities were then determined using the Short Time Fourier Transform method. The velocities, shown in FIG. 8, oscillate between a direction towards the probe and away from it, and range in peak value between 0.1 m/s and 0.2 m/s. A weak first harmonic in the velocity data, resulting from low-level nonlinearities in the detector, can be seen. These harmonics are readily identifiable as such, are smaller in magnitude than the fundamental signal of interest by about −30 dB (or a factor of 1000) and do not interfere with measurements of interest.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. A laser velocimetry system, the laser velocimetry system comprising:
a. a laser velocimeter, the laser velocimeter comprising:
i. a laser, wherein the laser provides a laser beam having a predetermined fixed wavelength;
ii. an optical probe optically coupled to the laser, wherein the optical probe directs the laser beam to a surface of a sample and receives Doppler shifted light reflected from the surface of the sample;
iii. a first multimode optical fiber having a first end optically coupled to the optical probe, wherein the first multimode optical fiber receives the Doppler shifted light reflected from the sample from the optical probe;
iv. a circulator optically coupled to a second end of the first multimode optical fiber, wherein the circulator receives the Doppler shifted light reflected from the sample and directs the Doppler shifted light to a detector that is optically coupled to the circulator by a second multimode optical fiber, wherein the detector receives unshifted light from the laser and the Doppler shifted light, and wherein the detector generates a signal from the unshifted light and the Doppler shifted light reflected from the surface of the sample; and
b. an analyzer, wherein the analyzer receives the signal form the detector and produces a digitized signal therefrom, and wherein the digitized signal is used to calculate at least one velocity of the surface of the sample.

2. The laser velocimetry system according to claim 1, wherein the laser beam has a power of up to 100 mW.

3. The velocimetry system according to claim 1, wherein the laser beam has a wavelength of about 1550 nm.

4. The velocimetry system according to claim 1, wherein the aiser beam has a line width up to 1 MHz.

5. The laser velocimetry system according to claim 1, wherein the optical fiber has a diameter in a range from about 9 microns to about 100 microns.

6. The laser velocimetry system according to claim 1, wherein each of the first multimode optical fiber and the second multimode optical fiber is one of a graded index optical fiber and a stepped index optical fiber.

7. The laser velocimetry system according to claim 1, wherein the optical probe comprises at least one of a lens, a tapered optical fiber, and a bare fiber optical probe.

8. The laser velocimetry system according to claim 1, wherein the detector comprises a photodiode.

9. The laser velocimetry system according to claim 1, wherein the analyzer comprises one of a transient digitizer and a digitizing oscilloscope.

10. The laser velocimetry system according to claim 1, wherein the laser is optically coupled to the optical probe by the first multimode optical fiber.

11. The laser velocimetry system according to claim 1 wherein the laser is one of a diode laser and a fiber laser.

12. The laser velocimetry system according to claim 1, further comprising a beam splitter optically coupled to the first multimode optical fiber, wherein the beam splitter splits a portion of the unshifted light from the laser and directs the unshifted light to the detector.

13. The laser velocimetry system according to claim 12, wherein the beam splitter is disposed between the circulatory and the optical probe.

14. The laser velocimetry system according to claim 12, wherein, the beam splitter is disposed between the laser and the circulator, and wherein the beam splitter directs the unshifted light through a third optical fiber to a combiner, the combiner being coupled to the second multimode optical fiber, wherein the unshifted light is directed by the combiner to the detector.

15. The laser velocimetry system according to claim 12, further comprising a variable retroreflector optically coupled to the beam splitter.

16. The laser velocimetry system according the claim 1, further comprising a fiber stretcher optically coupled to the first multimode optical fiber and disposed between the circulator and the optical probe.

17. A laser velocimeter, the laser velocimeter comprising:
a. a laser, wherein the laser provides a laser beam having a predetermined fixed wavelength;
b. a first multimode optical fiber optically coupled to the laser, wherein the first multimode optical fiber passes through a circulator that directs the laser beam through the first multimode optical fiber to an optical probe that is optically coupled to the first multimode optical fiber, wherein the optical probe directs the laser beam to a surface of a sample and receives Doppler shifted light reflected from the surface of the sample and transmits the Doppler shifted light reflected from the surface of the sample back through the first multimode optical fiber to the circulator, wherein the circulator directs the Doppler shifted light reflected from the surface of the sample into a second multimode optical fiber optically coupled to the circulator, and
c. a detector optically coupled to the circulator by the second multimode optical fiber, wherein the detector receives unshifted light from the laser and the Doppler shifted light reflected from the surface of the sample, and wherein the detector generates a signal from the unshifted light and the Doppler shifted light reflected from the surface of the sample.

18. A laser velocimeter system, the laser velocimeter system comprising:
a. a laser velocimeter, the laser velocimeter comprising:
i. a laser, wherein the laser is one of a diode laser and a fiber laser, and wherein the laser provides a laser beam having a power of up to 100 mW, and a predetermined fixed wavelength;
ii. a first multimode optical fiber optically coupled to the laser, wherein the first multimode optical fiber passes through a circulator that directs the laser beam through the first multimode optical fiber to an optical probe that is optically coupled to the first multimode optical fiber, wherein the optical probe directs the laser beam to a surface of a sample and receives Doppler shifted light reflected from the surface of the sample, wherein the optical probe transmits the Doppler shifted light reflected from the surface of the sample back through the first multimode optical fiber to the circulator, and wherein the circulator directs the Doppler shifted light reflected from the surface of the sample into a second multimode optical fiber optically coupled to the circulator; and
iii. a detector optically coupled to the circulator by the second multimode optical fiber, wherein the detector receives unshifted light from the laser and the Doppler shifted light reflected from the surface of the sample, and wherein the detector generates a signal from the unshifted light and the Doppler shifted light reflected from the surface of the sample; and
b. an analyzer, wherein the analyzer receives the signal form the detector and produces a digitized signal therefrom, and wherein the digitized signal is used to calculate at least one velocity of the surface of the sample.

19. A method of determining the velocity of a moving object, the method comprising the steps of:
a. directing a laser beam having a predetermined fixed wavelength to a surface of the moving object;
b. receiving Doppler shifted light reflected from the surface using an optical probe;
c. transmitting the Doppler shifted light reflected from the surface from the optical probe through a first multimode optical fiber to a circulator;
d. directing the Doppler shifted light reflected from the surface from the circulator to a second multimode optical fiber;
e. transmitting unshifted light from the laser and the Doppler shifted light reflected from the surface Through the second multimode fiber to a detector, wherein the detector generates a signal from the unshifted light and the Doppler shifted light reflected from the surface: and
f. determining the velocity from the signal.

20. The method according the claim 19, wherein the step of directing the laser beam to the surface of the moving object comprises directing the laser beam through the first multimode optical fiber end the optical probe to the surface.

21. The method according to claim 19, further including the steps of:
a. transmitting the signal from the detector to an analyzer, and
b. producing a digitized signal in the analyzer from the signal.
